(19) United States
(12) Patent Application Publication
(10) Pub. No.: US 2024/0127719 A1
(43) Pub. Date: Apr. 18, 2024

(54) Signage Displaying Device

(71) Applicant: Amy Alexander, De Pere, WI (US)

(72) Inventor: Amy Alexander, De Pere, WI (US)

(21) Appl. No.: 17/965,521

(22) Filed: Oct. 13, 2022

(51) Int. Cl. G09F 7/18

(52) U.S. Cl. CPC G09F 7/18; G09F 2007/1843

(57) ABSTRACT

A signage displaying device for increasing visibility of signage includes a pair of frames, each comprising a pair of vertical members to which are attached a plurality of crossmembers. A hinge is attached to and extends between a respective vertical member of one of the frames and a respective vertical member of the other of the frames. The hinge defines a vertical axis about which the frames are selectively hingable. Associated connectors of a plurality of connectors attached to the frames selectively engage a panel to removably engage the panel to a respective frame. Mounting elements attached singly to lower ends of the vertical members engage the pair of frames to a substantially horizontal surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to display devices and more particularly pertains to a new display device for increasing visibility of signage. The present invention discloses a display device comprising a pair of hingedly connected frames which are mountable in a perpendicular manner to a substantially horizontal surface.

### (2) Description of Related Art Including Information Disclosed Under 37 CFR 1.97 and 1.98

The prior art relates to display device, which may comprise flag shaped signs having spiked posts, rotatable display devices having three faces, and frames configured for insertion of panels and which have spikes or elongate footings. What is lacking in the prior art is a display device comprising a pair of frames which are hingedly connected, mountable in a perpendicular manner to a substantially horizontal surface, and to which panels can be attached.

### BRIEF SUMMARY OF THE INVENTION

An embodiment of the disclosure meets the needs presented above by generally comprising a pair of frames, each comprising a pair of vertical members and a plurality of crossmembers. Each crossmember is attached to and extends between the vertical members. A hinge is attached to and extends between a respective vertical member of one of the frames and a respective vertical member of the other of the frames. The hinge defines a vertical axis about which the frames are selectively hingable. Associated connectors of a plurality of connectors attached to the frames are configured to selectively engage a respective panel to removably engage the respective panel to a respective frame. Each mounting element of a plurality of mounting elements is attached to a lower end of a respective vertical member and is configured to engage a substantially horizontal surface. The pair of frames thus is removably engaged to the substantially horizontal surface with the vertical members being substantially perpendicular to the substantially horizontal surface.

Another embodiment of the disclosure includes a signage displaying system, which comprises a signage displaying device, as disclosed above, which is engaged to a substantially horizontal surface and frames of which have at least one panel engaged thereto.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a signage displaying device according to an embodiment of the disclosure.

FIG. 2 is a top view of an embodiment of the disclosure.

FIG. 3 is a front view of an embodiment of the disclosure.

FIG. 4 is a rear view of an embodiment of the disclosure.

FIG. 5 is an in-use view of an embodiment of the disclosure.

### DETAILED DESCRIPTION OF THE INVENTION

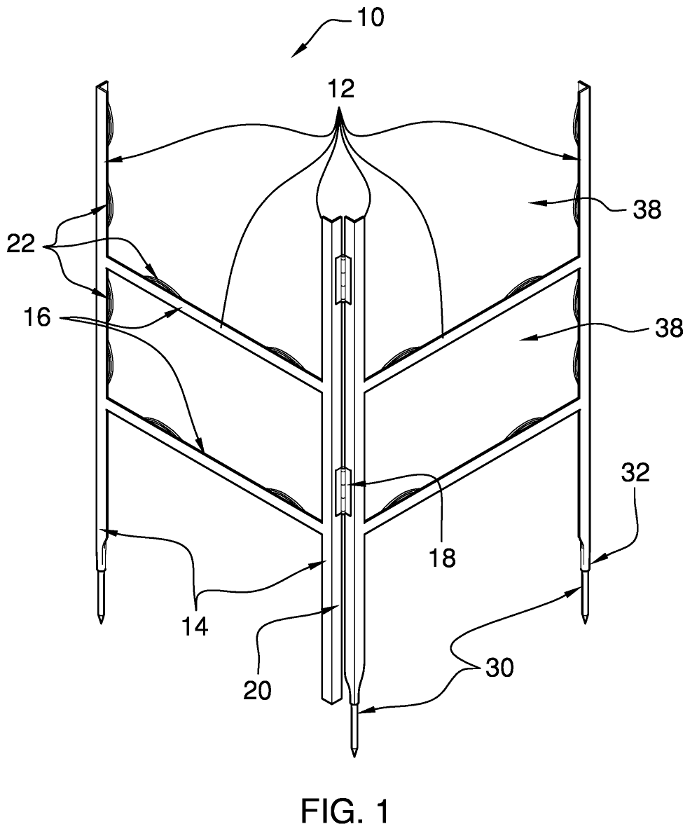

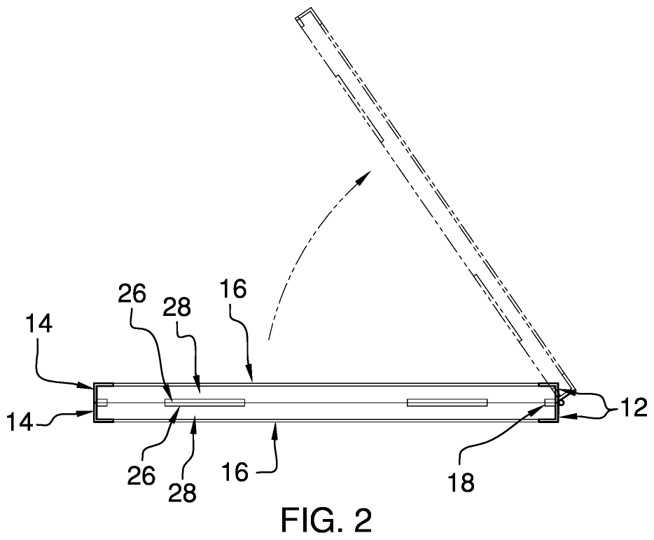

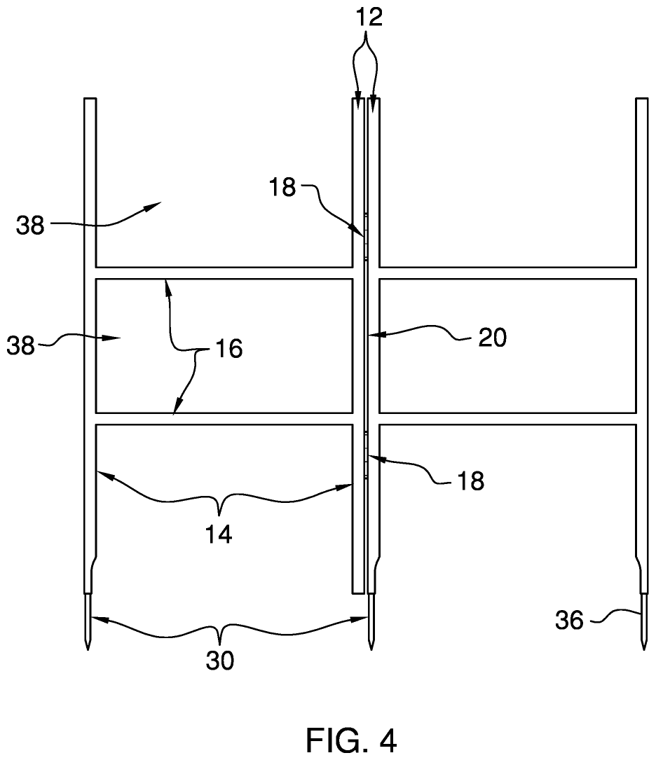

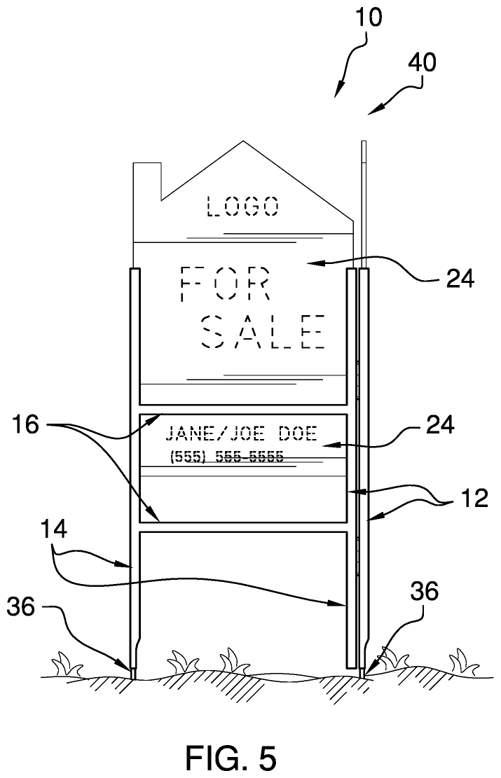

With reference now to the drawings, and in particular to FIGS. 1 through 5 thereof, a new display device embodying the principles and concepts of an embodiment of the disclosure and generally designated by the reference numeral 10 will be described.

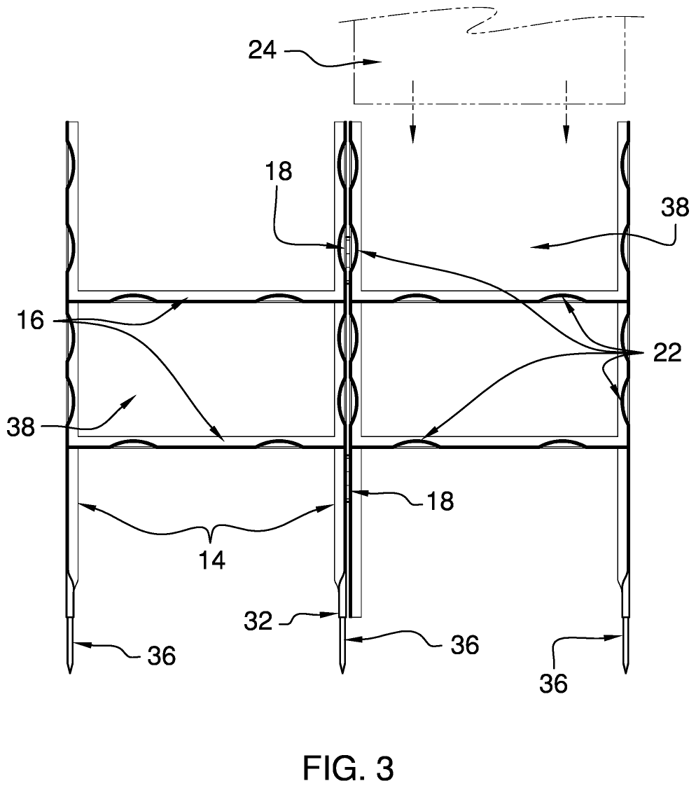

As best illustrated in FIGS. 1 through 5, the signage displaying device 10 generally comprises a pair of frames 12, each comprising a pair of vertical members 14 and a plurality of crossmembers 16. Each crossmember 16 is attached to and extends between the vertical members 14. The frame 12 is, generally, substantially rectangular, although the present invention also anticipates vertical members 14 of differing lengths. As shown in FIG. 3, the plurality of crossmembers 16 comprises two crossmembers 16, which define two display areas 38 within the frame 12. The crossmembers 16 and the vertical members 14 may comprise L-channel, C-channel, or the like.

A hinge 18 is attached to and extends between a respective vertical member 14 of one of the frames 12 and a respective vertical member 14 of the other of the frames 12. The hinge 18 defines a vertical axis 20 about which the frames 12 are selectively hingable. As shown in FIG. 1, two hinges 18 extend between the frames 12. The present invention also anticipates three or more hinges 18, a single piano hinge, living hinges, or the like.

Associated connectors 22 of a plurality of connectors 22 attached to the frames 12 are configured to selectively engage a respective panel 24 to removably engage the respective panel 24 to a respective frame 12. Each connector 22 may comprise a tab 26 so that the associated connectors 22 and the frame 12 define a slot 28. The slot 28 is configured for insertion of the respective panel 24. The present invention anticipates the connector 22 comprising other connecting means, such as, but not limited to, adhesives, magnets, clips, or the like.

Representative panels 24 may include panels 24 used by realtors in the process of listing and selling real estate and panels 24 used by retailers, rummage sellers, activity promoters, and the like. The present invention also anticipates one or more panels 24 being integral to the frame 12. For example, one or more whiteboards or blackboards could be integral to the frame 12, thereby allowing a user to add and to change indicia at will. The present invention is anticipated to be of particular use as it allows for attachment of a wide variety of panels 24 for different purposes and is deployable in a variety of configurations. For example, prior art display devices comprising a single frame are limited in positioning, in that they can reasonably be positioned perpendicular to or in parallel to a street. The frames 12 of the of the present invention, being hingedly paired, are positionable with the frames 12 at a variety of angles, such as 45°, 90°, and 135°.

Each mounting element 30 of a plurality of mounting elements 30 is attached to a lower end 32 of a respective vertical member 14 and is configured to engage a substantially horizontal surface 34. The pair of frames 12 thus is removably engaged to the substantially horizontal surface 34 with the vertical members 14 being substantially perpendicular to the substantially horizontal surface 34. As shown in FIG. 3, the mounting element 30 comprises a spike 36. The spike 36 is configured for insertion into the substantially horizontal surface 34, such as soil, sand, and the like. The present invention anticipates the mounting elements 30 being removably attachable to the vertical members 14. The present invention also anticipates the mounting elements 30 comprising other mounting means, such as, but not limited to cement blocks, sandbags, plates, or the like, which would allow for positioning of the frames 12 on a hard surface, such as a sidewalk, parking lot, or the like.

The present invention also anticipates a signage displaying system 40, which comprises a signage displaying device 10, as disclosed above, which is engaged to a substantially horizontal surface 34. The frames 12 of the signage displaying system 40 have at least one panel 24 engaged thereto.

In use, the frames 12 of the pair of frames 12 are hinged about the vertical axis 20 into a desired configuration, the spikes 36 then are inserted into the substantially horizontal surface 34, and respective panels 24 are inserted into the slots 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A signage displaying device comprising:
a pair of frames, each frame comprising:
a pair of vertical members, and
a plurality of crossmembers, each crossmember being attached to and extending between the vertical members;
a hinge attached to and extending between a respective vertical member of one of the frames and a respective vertical member of the other of the frames, such that the hinge defines a vertical axis about which the frames are selectively hingable;
a plurality of connectors attached to the frames, each connector being configured for selectively engaging a panel, wherein associated connectors are configured for selectively engaging a respective panel for removably engaging the respective panel to a respective frame; and
a plurality of mounting elements, each mounting element being attached to a lower end of a respective vertical member and being configured for engaging a substantially horizontal surface, such that the pair of frames is removably engaged to the substantially horizontal surface with the vertical members are substantially perpendicular to the substantially horizontal surface.

2. The signage displaying device of claim 1, wherein the frame is substantially rectangular.

3. The signage displaying device of claim 1, wherein the plurality of crossmembers comprises two crossmembers defining two display areas within the frame.

4. The signage displaying device of claim 1, wherein the crossmembers and the vertical members comprise L-channel or C-channel.

5. The signage displaying device of claim 1, wherein each connector comprises a tab, such that the associated connectors and the frame define a slot, wherein the slot is configured for insertion of the respective panel.

6. The signage displaying device of claim 1, wherein the mounting element comprises a spike, wherein the spike is configured for insertion into the substantially horizontal surface.

7. A signage displaying device comprising:
a pair of frames, each frame comprising:
a pair of vertical members, and
a plurality of crossmembers, each crossmember being attached to and extending between the vertical members, the frame being substantially rectangular, the plurality of crossmembers comprising two crossmembers defining two display areas within the frame, the crossmembers and the vertical members comprising L-channel or C-channel;
a hinge attached to and extending between a respective vertical member of one of the frames and a respective vertical member of the other of the frames, such that the hinge defines a vertical axis about which the frames are selectively hingable;
a plurality of connectors attached to the frames, each connector being configured for selectively engaging a panel, wherein associated connectors are configured for selectively engaging a respective panel for removably engaging the respective panel to a respective frame, each connector comprising a tab, such that the associated connectors and the frame define a slot, wherein the slot is configured for insertion of the respective panel; and
a plurality of mounting elements, each mounting element being attached to a lower end of a respective vertical member and being configured for engaging a substantially horizontal surface, such that the pair of frames is removably engaged to the substantially horizontal surface with the vertical members are substantially perpendicular to the substantially horizontal surface, the mounting element comprising a spike, wherein the spike is configured for insertion into the substantially horizontal surface.

8. A signage displaying system comprising:
a pair of frames, each frame comprising:
a pair of vertical members, and
a plurality of crossmembers, each crossmember being attached to and extending between the vertical members;
a hinge attached to and extending between a respective vertical member of one of the frames and a respective vertical member of the other of the frames, such that the hinge defines a vertical axis about which the frames are selectively hingable;
at least one panel attached to the frames by a plurality of connectors; and
a plurality of mounting elements, each mounting element being attached to a lower end of a respective vertical member and engaged to a substantially horizontal surface, such that the vertical members are substantially perpendicular to the substantially horizontal surface.

9. The signage displaying system of claim 8, wherein the frame is substantially rectangular.

10. The signage displaying system of claim 8, wherein the plurality of crossmembers comprises two crossmembers defining two display areas within the frame.

11. The signage displaying system of claim 8, wherein the crossmembers and the vertical members comprise L-channel or C-channel.

12. The signage displaying system of claim 8, wherein each connector comprises a tab, such that the associated connectors and the frame define a slot, the respective panel being inserted into the slot.

13. The signage displaying system of claim 8, wherein the mounting element comprises a spike inserted into the substantially horizontal surface.
